(19) United States
(12) Patent Application Publication
(10) Pub. No.: US 2010/0057703 A1
(43) Pub. Date: Mar. 4, 2010

(54) Systems and Methods for Automating Software Updates/Maintenance

(76) Inventors: Matthew K. Brandt, Driftwood, TX (US); Michael J. Burkett, Austin, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 12/201,506

(22) Filed: Aug. 29, 2008

(51) Int. Cl. G06F 17/30

(52) U.S. Cl. 707/4; 707/E17.014

(57) ABSTRACT

In various embodiments, a license code may be provided for determining if a device has a license for new software. In some embodiments, a license system may receive a query from a device. In some embodiments, the query may include an identifier unique to the device. The license system may access a database to determine if the device associated with the unique identifier is has a license to install new software (e.g., a software update). If the device has a license, the license system may generate and send a license code for the device. In some embodiments, when the user and/or device receives the license code, the device may use the license code to determine if the device is authorized to install the new software.

### BACKGROUND

Many systems today, in addition to computer systems, run software that is capable of being updated (e.g., video conferencing systems, set-top boxes, gaming consoles, etc). Updates may be made available periodically throughout the life of the system. Often from the time a new system is boxed and shipped to a consumer, the software on the system may become outdated during the time the system is shipping. Electronic distribution of software and software updates allows systems to be more easily updated. For example, software and software updates may be distributed to a system over an Internet connection. Software developers may generate revenue from licenses to software and software updates that are electronically distributed. However, electronic distribution may lead to an increase in illegal downloads and/or illegal copies of software and software updates.

### SUMMARY

In various embodiments, a license system may receive a query from a device or group of devices (e.g., through a management system). In some embodiments, the query may include an identifier (e.g., a serial number or a MAC (Media Access Control) address) unique to one or more devices. The license system may access a database to determine if the device associated with the unique identifier has a license. If the device has a license, the license system may generate a license code and send the license code to the device (or, for example, a user of the device, a management system, etc). In some embodiments, the license code may include information corresponding to the information associated with the license. In some embodiments, other license data may be sent to the device along with the license code.

In some embodiments, when the user and/or device receives the license code, the device may use the license code to determine if the device is authorized for maintenance activities associated with a license. For example, determining if the device is authorized for maintenance activities may include verifying the license code (e.g., verifying a digital signature in the license code using a local key) and comparing a date associated with the expiration of the license to a date associated with the maintenance activity. When the device accesses new software (e.g., a software update) the device may compare a date of the new software to an embedded date in the license code (or, for example, an unencrypted date sent along with the license code) to determine if the device has a license to install the new software. If the date indicated in the code indicates the device is covered by a license for the date, the new software may be installed in the device. If not, the user may be notified (e.g., with a link to a web page where the user can purchase a license for new software).

### BRIEF DESCRIPTION OF THE DRAWINGS

A better understanding of the present invention may be obtained when the following detailed description is considered in conjunction with the following drawings, in which:

FIG. 1a illustrates a device and a license system, according to an embodiment.

FIG. 1b illustrates a video conferencing endpoint network, according to an embodiment.

FIG. 2 illustrates a video conferencing endpoint, according to an embodiment.

FIGS. 3a-e illustrate interactions between the device and the license system, according to various embodiments.

FIG. 4 illustrates a flowchart of a method for providing a license code to a device, according to an embodiment.

FIG. 5 illustrates a flowchart of a method for providing a license code to a device through a web page, according to an embodiment.

FIG. 6 illustrates a flowchart of a method for providing a license code to a device from a video conferencing system, according to an embodiment.

FIG. 7 illustrates a flowchart of a method for using a license code in a device, according to an embodiment.

FIG. 8 illustrates a database for license information, according to an embodiment.

FIG. 9 illustrates a code generation algorithm, according to an embodiment.

FIGS. 10a-c illustrate web pages for license code distribution, according to an embodiment.

FIG. 11 illustrates a flowchart of a method for sending multiple license codes from the license system for multiple devices, according to an embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must). The term “include”, and derivations thereof, mean “including, but not limited to”. The term “coupled” means “directly or indirectly connected”.

### DETAILED DESCRIPTION OF THE EMBODIMENTS

### Incorporation by Reference

U.S. Patent Application titled “Speakerphone”, Ser. No. 11/251,084, which was filed Oct. 14, 2005, whose inventor is William V. Oxford is hereby incorporated by reference in its entirety as though fully and completely set forth herein.

U.S. Patent Application titled “Videoconferencing System Transcoder”, Ser. No. 11/252,238, which was filed Oct. 17, 2005, whose inventors are Michael L. Kenoyer and Michael V. Jenkins, is hereby incorporated by reference in its entirety as though fully and completely set forth herein.

U.S. Patent Application titled “Speakerphone Supporting Video and Audio Features”, Ser. No. 11/251,086, which was filed Oct. 14, 2005, whose inventors are Michael L. Kenoyer, Craig B. Malloy and Wayne E. Mock is hereby incorporated by reference in its entirety as though fully and completely set forth herein.

U.S. Patent Application titled “Virtual Decoders”, Ser. No. 12/142,263, which was filed Jun. 19, 2008, whose inventors are Keith C. King and Wayne E. Mock, is hereby incorporated by reference in its entirety as though fully and completely set forth herein.

U.S. Patent Application titled “Video Conferencing System which Allows Endpoints to Perform Continuous Presence Layout Selection”, Ser. No. 12/142,302, which was filed Jun. 19, 2008, whose inventors are Keith C. King and Wayne E. Mock, is hereby incorporated by reference in its entirety as though fully and completely set forth herein.

U.S. Patent Application titled “Video Conferencing Device which Performs Multi-way Conferencing”, Ser. No. 12/142,340, which was filed Jun. 19, 2008, whose inventors are Keith C. King and Wayne E. Mock, is hereby incorporated by reference in its entirety as though fully and completely set forth herein.

U.S. Patent Application titled “Video Decoder which Processes Multiple Video Streams”, Ser. No. 12/142,377, which was filed Jun. 19, 2008, whose inventors are Keith C. King and Wayne E. Mock, is hereby incorporated by reference in its entirety as though fully and completely set forth herein.

U.S. Patent Application titled “Virtual Multiway Scaler Compensation”, Ser. No. 12/171,358, which was filed Jul. 11, 2008, whose inventors are Keith C. King and Wayne E. Mock, is hereby incorporated by reference in its entirety as though fully and completely set forth herein.

U.S. Patent Application titled “Integrated Videoconferencing System”, Ser. No. 11/405,686, which was filed Apr. 17, 2006, whose inventors are Michael L. Kenoyer, Patrick D. Vanderwilt, Craig B. Malloy, William V. Oxford, Wayne E. Mock, Jonathan I. Kaplan, and Jesse A. Fourt is hereby incorporated by reference in its entirety as though fully and completely set forth herein.

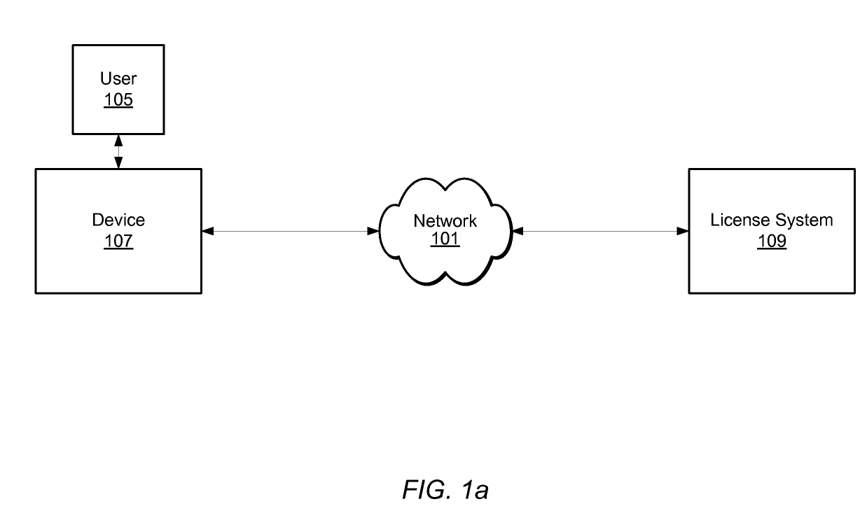

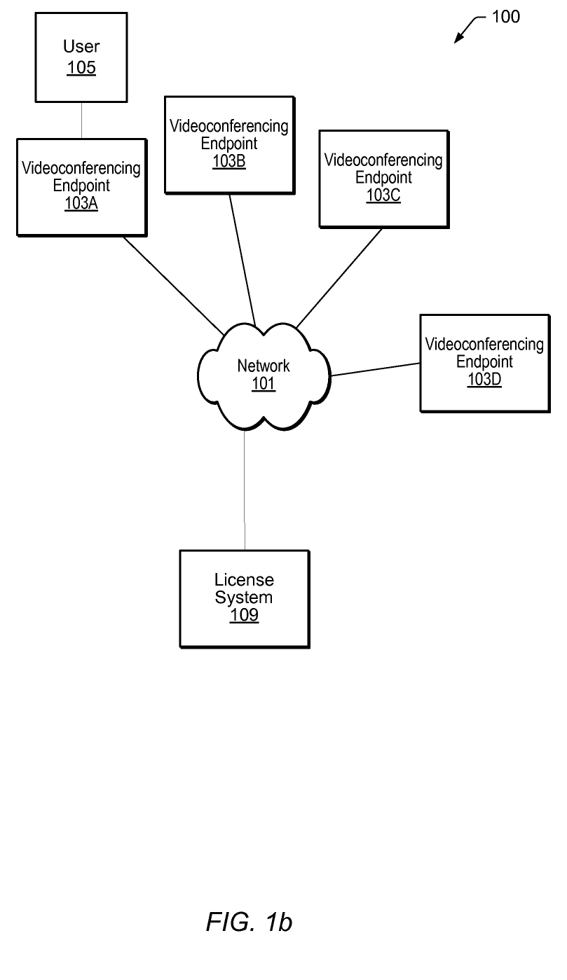

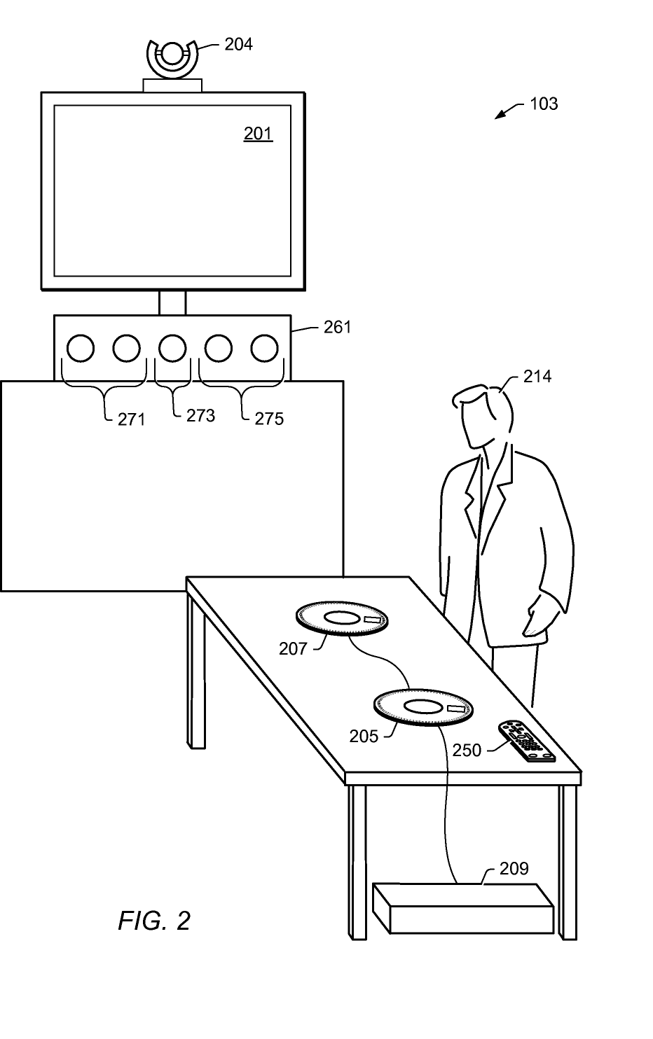

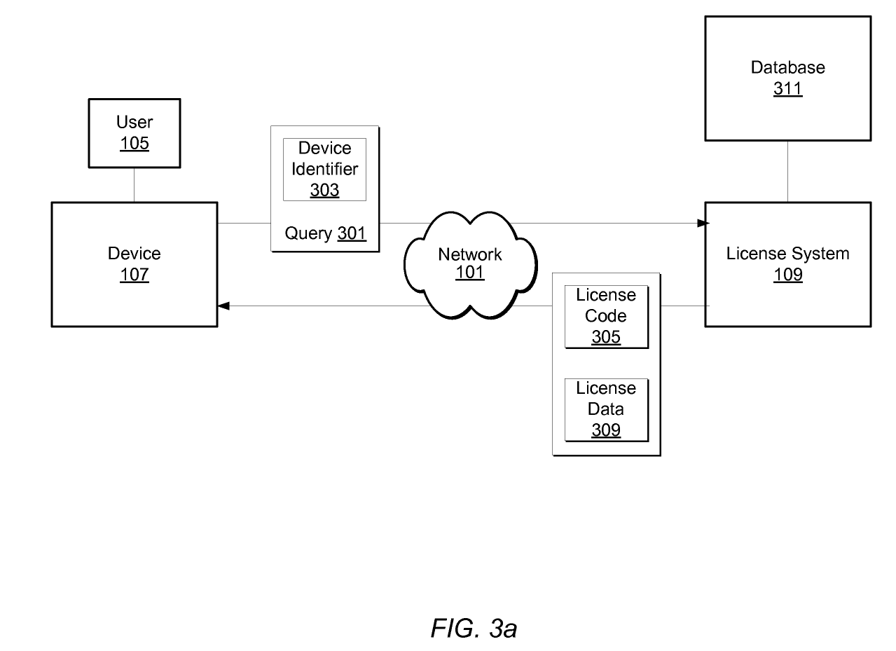

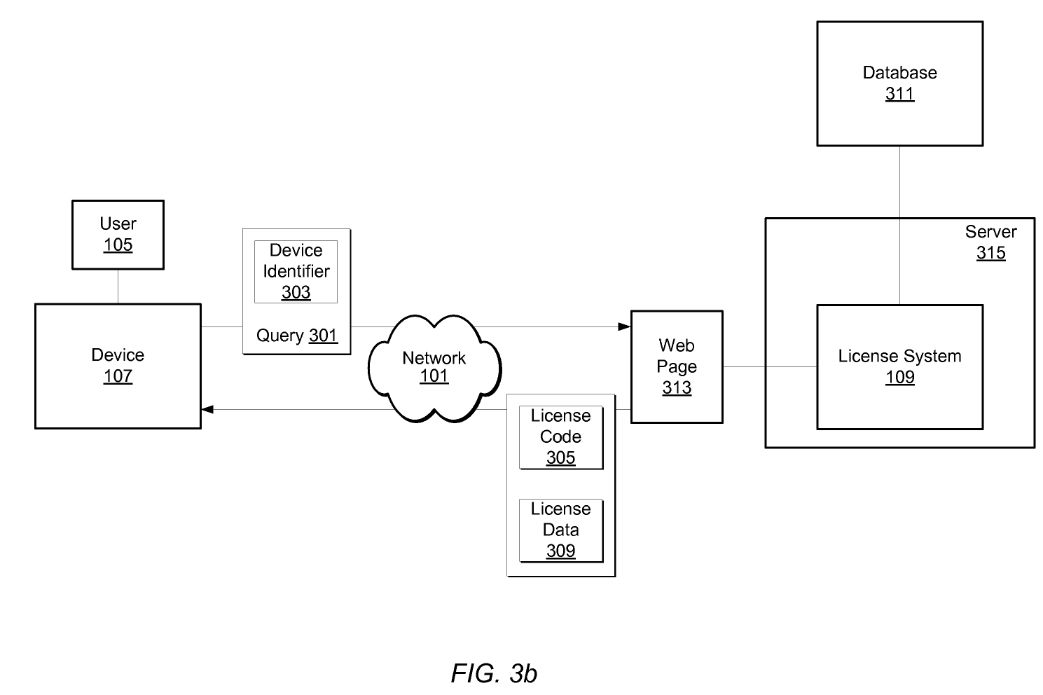

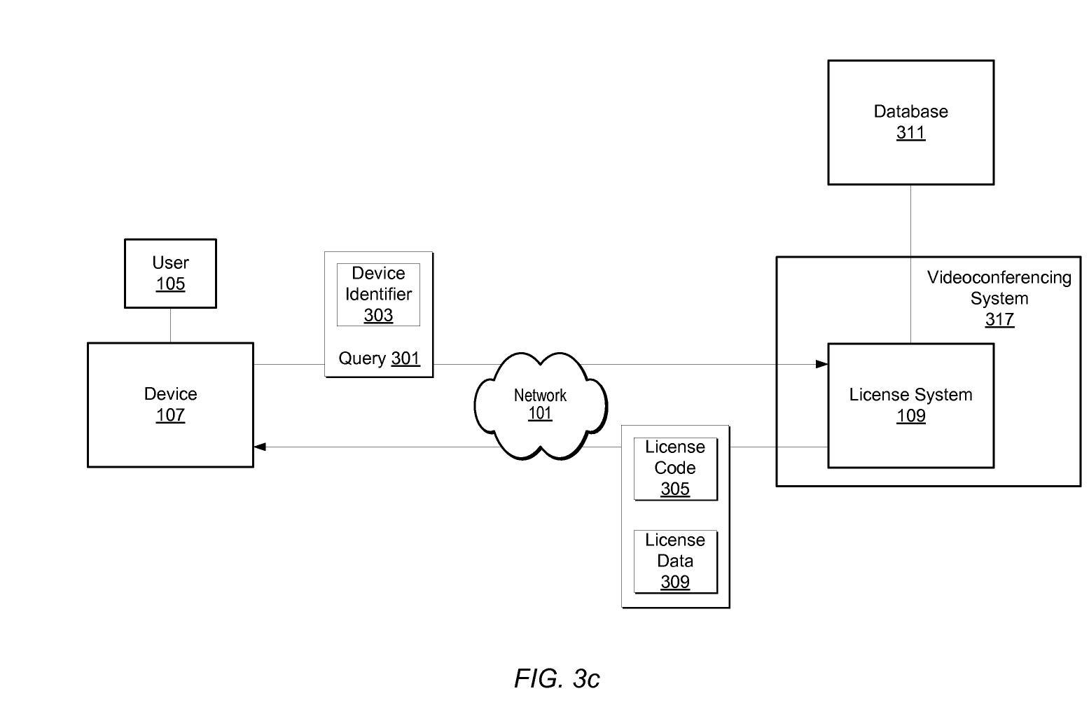

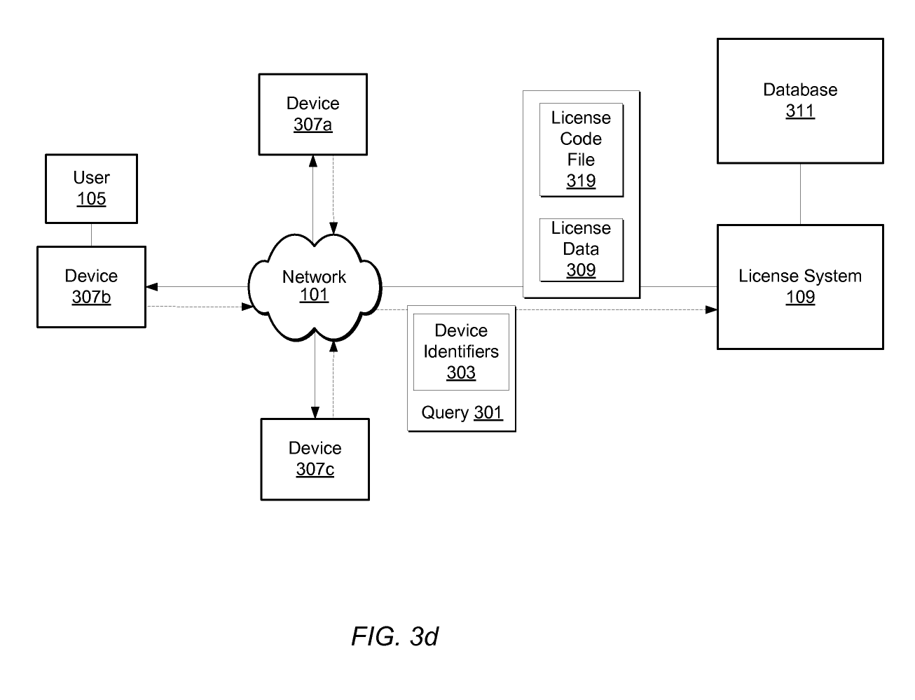

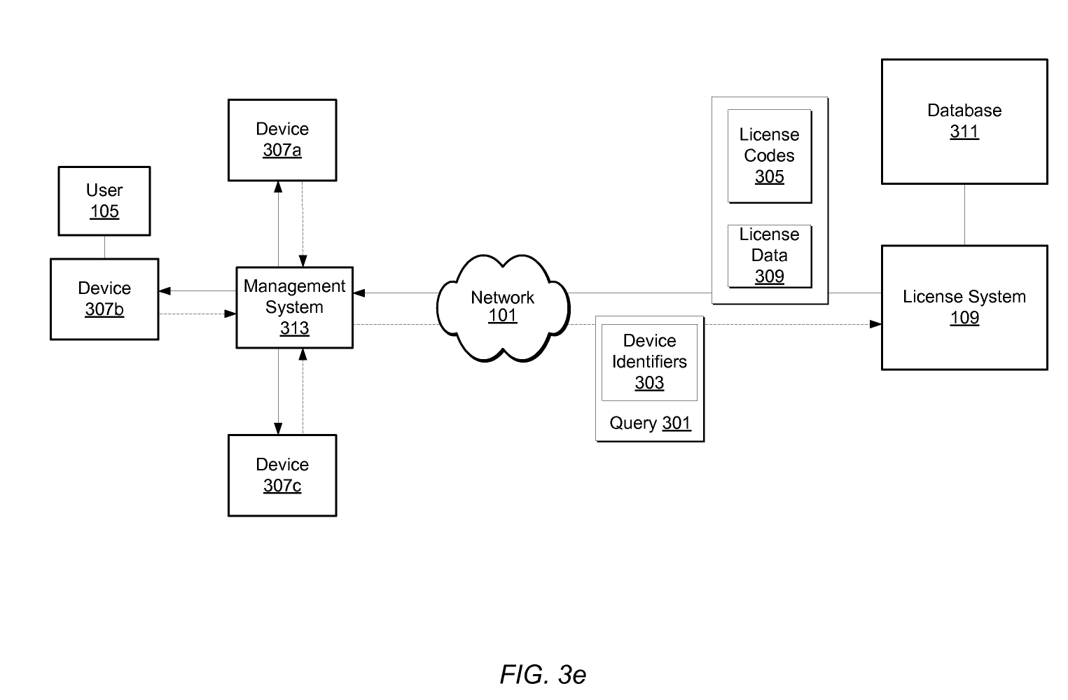

FIG. 1a illustrates device 107 and license system 109, according to an embodiment. In various embodiments, device 107 may receive license code 305 (e.g., see FIGS. 3a-c) from license system 109 for use in determining if device 107 has a license to install new software (e.g., a full software program or software update). As used herein, “license” may refer to a new software license or a maintenance agreement (e.g., to receive software updates, etc). Other licenses are also contemplated. In some embodiments, device 107 may be codec 209, speakerphone 205/207, camera 204, etc. on videoconferencing endpoint 103 (e.g., see FIGS. 1b and 2). Other devices 107 are also contemplated (e.g., a computer system, set-top box, gaming console, etc). In some embodiments, license system 109 may include executable program instructions on server 315 (e.g., see FIG. 3b) or video conferencing system 317 (e.g., see FIG. 3c)). For example, server 315 may be an HTTP (Hypertext Transfer Protocol) server. Other locations for license system 109 are also contemplated (e.g., on a PDA (Personal Digital Assistant) or other computer system). In some embodiments, device 107 may access license system 109 through network 101. Other access mechanisms are also contemplated (e.g., license system 109 may be resident on a PDA and may access device 107 wirelessly). In some embodiments, device 107 and license system 109 may use encryption keys (e.g., public, private, or symmetric keys) to encrypt communications between each other. In some embodiments, respective keys may be installed on device 107 and/or license system 109 at the factory, provided by user 105 (e.g., through a USB (Universal Serial Bus) dongle, manually provided by user 105), etc. For example, user 105 may receive a public, private, or symmetric key over the phone and may type the public, private, or symmetric key into device 107. Other public, private, or symmetric key distributions are also contemplated.

FIG. 1b illustrates an embodiment of video conferencing endpoint network 100. FIG. 1b illustrates an exemplary embodiment of video conferencing endpoint network 100 which may include network 101 and multiple endpoints 103a-103d (e.g., video conferencing endpoints). Although not shown in FIG. 1b, video conferencing system network 100 may also include other devices, such as gateways, a service provider, conference units, and plain old telephone system (POTS) telephones, among others. Endpoints 103a-103d may be coupled to network 101 via gateways (not shown). Gateways may each include firewall, network address translation (NAT), packet filter, and/or proxy mechanisms, among others. Endpoints 103a-d (and/or equipment at endpoints 103a-d) may also be able to access license system 109 through network 101.

Endpoints 103a-103d may include video conferencing system endpoints (also referred to as “participant locations”). Each endpoint 103a-103d may include a camera, display device, microphone, speakers, and a codec or other type of video conferencing hardware. In some embodiments, endpoints 103a-103d may include video and voice communications capabilities (e.g., video conferencing capabilities) and include or be coupled to various audio devices (e.g., microphones, audio input devices, speakers, audio output devices, telephones, speaker telephones, etc.) and include or be coupled to various video devices (e.g., monitors, projectors, displays, televisions, video output devices, video input devices, cameras, etc.). In some embodiments, endpoints 103a-103d may include various ports for coupling to one or more devices (e.g., audio devices, video devices, etc.) and/or to one or more networks. Endpoints 103a-103d may each include and/or implement one or more real time protocols, e.g., session initiation protocol (SIP), H.261, H.263, H.264, H.323, among others. In an embodiment, endpoints 103a-103d may implement H.264 encoding for high definition (HD) video streams.

Network 101 may include a wide area network (WAN) such as Internet. Network 101 may include a plurality of networks coupled together, e.g., one or more local area networks (LANs) coupled to the Internet. Network 101 may also include public switched telephone network (PSTN). Network 101 may also include an Integrated Services Digital Network (ISDN) that may include or implement H.320 capabilities. In various embodiments, video and audio conferencing may be implemented over various types of networked devices.

In some embodiments, endpoints 103a-103d may each include various wireless or wired communication devices that implement various types of communication, such as wired Ethernet, wireless Ethernet (e.g., IEEE 802.11), IEEE 802.16, paging logic, RF (radio frequency) communication logic, a modem, a digital subscriber line (DSL) device, a cable (television) modem, an ISDN device, an ATM (asynchronous transfer mode) device, a satellite transceiver device, a parallel or serial port bus interface, and/or other type of communication device or method.

In various embodiments, the methods and/or systems described may be used to implement connectivity between or among two or more participant locations or endpoints, each having voice and/or video devices (e.g., endpoints 103a-103d) that communicate through network 101.

In some embodiments, video conferencing system network 100 (e.g., endpoints 103a-d) may be designed to operate with network infrastructures that support T1 capabilities or less, e.g., 1.5 mega-bits per second or less in one embodiment, and 2 mega-bits per second in other embodiments. In some embodiments, other capabilities may be supported (e.g., 6 mega-bits per second, over 10 mega-bits per second, etc). The video conferencing endpoint may support HD capabilities. The term “high resolution” includes displays with resolution of 1280×720 pixels and higher. In one embodiment, high-definition resolution may include 1280×720 progressive scans at 60 frames per second, or 1920×1080 interlaced or 1920×1080 progressive. Thus, an embodiment of the present invention may include a video conferencing endpoint with HD “e.g. similar to HDTV” display capabilities using network infrastructures with bandwidths T1 capability or less. The term “high-definition” is intended to have the full breath of its ordinary meaning and includes “high resolution”.

FIG. 2 illustrates an exemplary embodiment of video conferencing endpoint 103 (e.g., endpoint 103a), also referred to as a participant location. Endpoint 103 may have system codec box 209 to manage both speakerphone 205/207 and the video conferencing devices. Speakerphones 205/207 and other video conferencing endpoint components may be coupled to codec box 209 and may receive audio and/or video data from system codec box 209.

In some embodiments, endpoint 103 may include camera 204 (e.g., an HD camera) for acquiring video images of the participant location (e.g., of participant 214). Other cameras are also contemplated. Endpoint 103 may also include display 201 (e.g., an HDTV display). Video images acquired by camera 204 may be displayed locally on display 201 and may also be encoded and transmitted to other video conferencing endpoints 103 in the video conference.

Endpoint 103 may also include sound system 261. Sound system 261 may include multiple speakers including left speakers 271, center speaker 273, and right speakers 275. Other numbers of speakers and other speaker configurations may also be used. Endpoint 103 may also use one or more speakerphones 205/207 which may be daisy chained together.

In some embodiments, the video conferencing endpoint components (e.g., camera 204, display 201, sound system 261, and speakerphones 205/207) may be coupled to system codec (“compressor/decompressor”) box 209. System codec box 209 may be placed on a desk or on a floor. Other placements are also contemplated. System codec box 209 may receive audio and/or video data from a network (e.g., network 101). System codec box 209 may send the audio to speakerphone 205/207 and/or sound system 261 and the video to display 201. The received video may be HD video that is displayed on the HD display. System codec box 209 may also receive video data from camera 204 and audio data from speakerphones 205/207 and transmit the video and/or audio data over network 101 to another conferencing system. The conferencing system may be controlled by participant 214 through the user input components (e.g., buttons) on speakerphones 205/207 and/or remote control 250. Other system interfaces may also be used.

In various embodiments, system codec box 209 may implement a real time transmission protocol. In some embodiments, system codec box 209 may include any system and/or method for encoding and/or decoding (e.g., compressing and decompressing) data (e.g., audio and/or video data). In some embodiments, system codec box 209 may not include one or more of the compressing/decompressing functions. In some embodiments, communication applications may use system codec box 209 to convert an analog signal to a digital signal for transmitting over various digital networks (e.g., network 101, PSTN 120, the Internet, etc.) and to convert a received digital signal to an analog signal. In various embodiments, codecs may be implemented in software, hardware, or a combination of both. Some codecs for computer video and/or audio may include MPEG, Indeo™, and Cinepak™, among others.

In some embodiments, endpoint 103 may display different video images of various participants, presentations, etc. during the videoconference. Video to be displayed may be transmitted as video streams (e.g., video stream 300 as seen in FIG. 3) between endpoints 103.

FIGS. 3a-e illustrate interactions between device 107 and license system 109, according to various embodiments. In various embodiments, device 107 may send query 301 (which may include device identifier 303) over network 101 to license system 109. License system 109 may access database 311 to determine if device 107 associated with the device identifier 303 currently has a license to install new software. As licenses are issued and/or renewed, unique identifiers 303 and/or other information respective to licensed device 107 and/or the license may be entered into database 311. If the device 107 associated with the device identifier 303 in query 301 is under a current license, license system 109 may generate license code 305 and send license code 305 to device 107. In some embodiments, license code file 319 with multiple license codes 305 may be sent to multiple devices (e.g., devices 307a-c in FIG. 3d) (devices 307a-c are embodiments of device 107). Each device 307 may determine which license code 305 in license code file 319 it should use (e.g., using identifiers 303 encrypted into the respective license codes 305 or identifiers associated with license codes 305 (for example, positioned next to the license codes 305) in license code file 319). In some embodiments, management system 313 may collect a group of license codes 305 and may distribute license codes 305 to devices 307a-c that management system 313 manages. In some embodiments, other license data 309 may be sent to device 107 along with license code 305. Device 107 may use license code 305 to determine if device 107 is authorized to install new software (e.g., a software update). In some embodiments, device 107 may automatically send query 301, receive license code 305, make a license determination, and install the new software such that user 105 may not be aware of the updating process. In some embodiments, user 105 may participate and/or be made aware of portions of the updating process (e.g., user 105 may initiate sending query 301 and requesting the new software be installed).

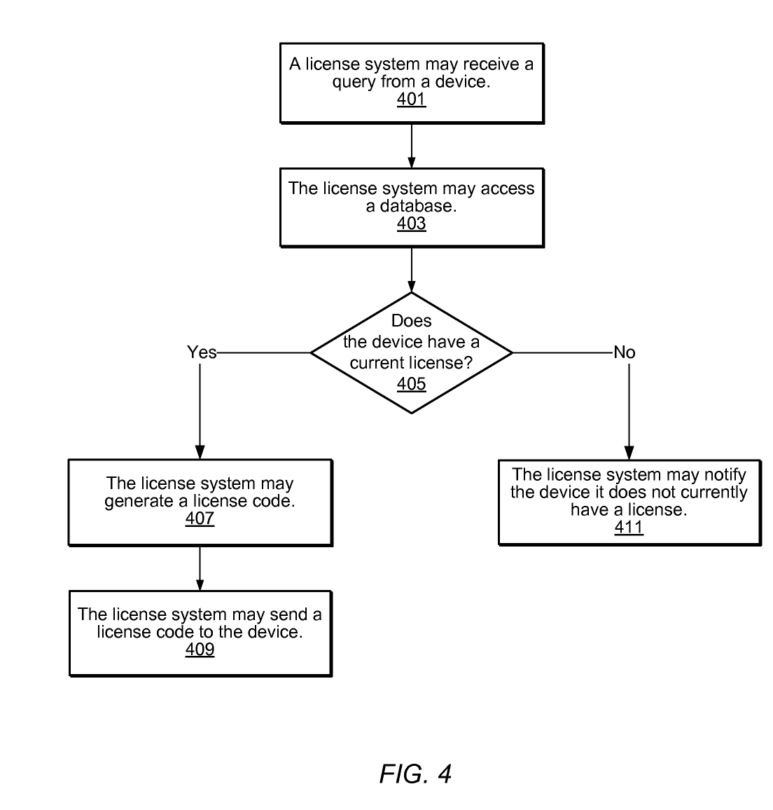

FIG. 4 illustrates a flowchart of an embodiment of a method for providing license code 305 to device 107 (see FIGS. 3a-c). It should be noted that in various embodiments of the methods described below, one or more of the elements described may be performed concurrently, in a different order than shown, or may be omitted entirely. Other additional elements may also be performed as desired. In some embodiments, a portion or the entire method may be performed automatically by a computer system.

At 401, license system 109 may receive query 301 from device 107 requesting license code 305 for device 107 to determine if device 107 is authorized to install new software. For example, device 107 may send query 301 when device 107 is first connected (e.g., out of the box) to network 101 (e.g., the Internet) to request license code 305 to install new product software updates. In some embodiments, device 107 may send query 301 when device 107 cannot locate license code 305 (for example, if device 107 has not previously received license code 305 or has lost license code 305 (e.g., during a device reset)). In some embodiments, device 107 may send query 301 to confirm or update license code 305 resident on device 107. In some embodiments, device 107 may send query 301 periodically (e.g., when device 107 is checking for software updates). In some embodiments, query 301 may include identifier 303 (e.g., a serial number or a MAC (Media Access Control) address) unique to device 107. In some embodiments, identifier 303 may not be unique to device 107 (e.g., identifier 303 may be an identifier (such as an IP (Internet Protocol) address) unique to a group of devices). In some embodiments, identifier 303 (e.g., a serial number) may be read from firmware on device 107 to be sent with query 301. In some embodiments, user 105 may enter identifier 303 into device 107 (e.g., by reading the serial number on an exterior case of device 107 and entering the serial number into a graphical interface using a keypad of device 107). Other identifiers 303 are also contemplated. In some embodiments, a derivative of the serial number and MAC address may be used as the identifier 303 (e.g., first 4 digits of serial number and first four digits of the MAC address). In some embodiments, query 301 may include a request for license code 305 or may include only unique identifier 303. Other query formats are also contemplated. In some embodiments, query 301 may be encrypted (e.g., using an Rivest, Shamir, & Adleman (RSA) certificate). Sending query 301 may involve establishing an HTTP connection, an FTP (File Transfer Protocol) connection, a videoconference call, etc. with license system 109.

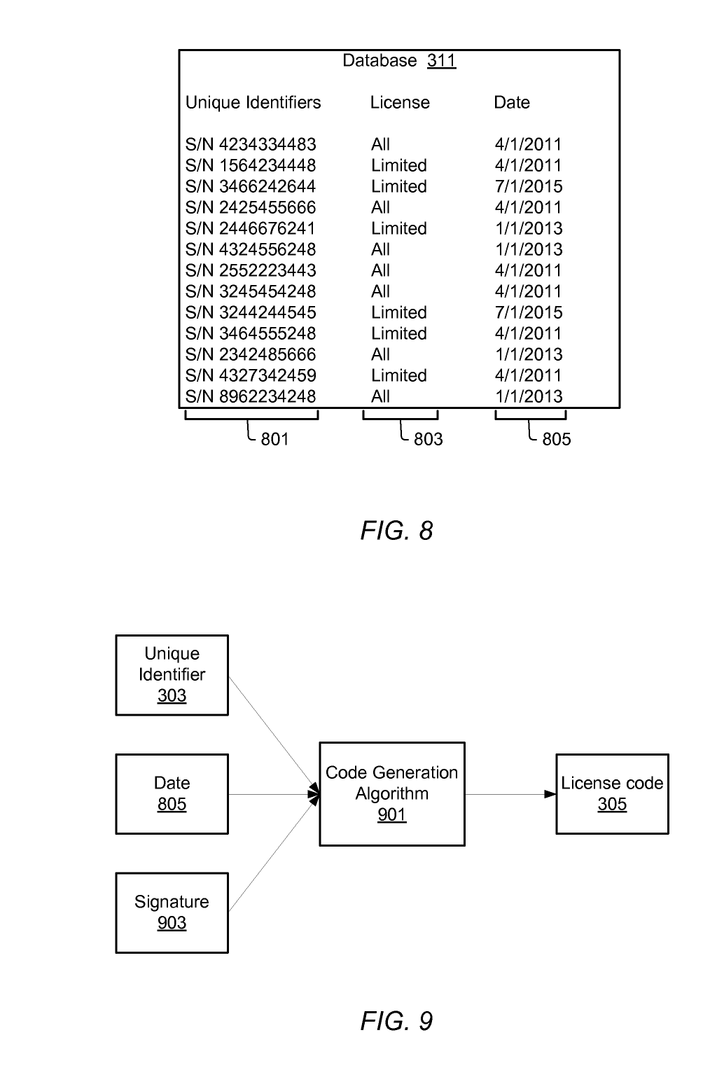

At 403, license system 109 may access database 311 (e.g., see FIGS. 3a-3c and FIG. 8) that includes license information associated with device 107 associated with unique identifier 303. In some embodiments, license system 109 may access license database 311, which may be local or remote to license system 109. In some embodiments, database 311 may be an Oracle™ database (other databases are also contemplated). In some embodiments, database 311 may include unique identifiers 303 (e.g., serial numbers (such as serial numbers 801 in FIG. 8) and/or MAC addresses for devices 107) and other corresponding license information (e.g., dates 805 corresponding to when a license terminates for respective devices 107 associated with unique identifiers 303). When device 107 ships (e.g., with an initial license) or when user 105 purchases/renews a license, unique identifier 303 for device 107 may be stored into database 311 with corresponding date 805 for the license. Other information may also be stored in database 311 (e.g., type 803 of license). In some embodiments, license information may include a digital signature 903 (e.g., see FIG. 9). Other license information is also contemplated.

At 405, license system 109 may determine if device 107 requesting the license currently has a license. For example, license system 109 may compare license date 805 in database 311 with the current date, and, if license date 805 (which may be an expiration date) is dated after the current date, license system 109 may consider the license for device 107 to be current. In some embodiments, license system 109 may also consider type 803 of license. Other license considerations are also contemplated.

At 407, if device 107 has a current license, license system 109 may generate license code 305. In some embodiments, license code 305 may include information corresponding to the information associated with the license. As seen in FIG. 9, license code 305 may be automatically generated by code generation algorithm 901 (e.g., implemented in software and/or hardware) using unique identifier 303 (e.g., device serial number 801), license expiration date 805, and signature 903 (e.g., a digital signature). Other information may also be used in generating license code 305 (e.g., type 803 of license). In some embodiments, license code 305 may be generated without including unique identifier 303, license expiration date 805, and/or signature 903. In some embodiments, code generation algorithm 901 may use encryption software to generate license code 305 (e.g., represented by a hash number) that can be deciphered by device 107 using, for example, a private, public, and/or symmetric key held by device 107. In some embodiments, code generation algorithm 901 may generate a hash of unique identifier 303, license expiration date 805, and/or signature 903 using an MD5 (Message-Digest algorithm 5) cryptographic hash function. In some embodiments, license code 305 may be an RSA signed certificate. Other encryption schemes are also contemplated (e.g., DES (Data Encryption Standard), triple-DES, AES (Advanced Encryption Standard), Diffie-Hellman, and DSA (digital signature algorithm)). In some embodiments, the private, public, or symmetric key may have been installed in device 107 at the factory and/or distributed to device 107 over network 101 (e.g., by license system 109). In some embodiments, license code 305 may include unique identifier 303, date 805, and signature placed in a designated format (e.g., left to right) and then encrypted. For example, if unique identifier 303 is 2425455666 and date is Apr. 1, 2011 and the signature is 8334332, the three numbers may be placed together (e.g., 2425455666040120118334332) and the placed together number may be encrypted (e.g., using MD5 or RSA). In some embodiments, an MD5 hash may be generated for the three numbers and the MD5 hash may be further encrypted (e.g., using another encryption method). Other encryption schemes are also contemplated.

In some embodiments, license code 305 may include an encrypted digital signature and other license data 309 (e.g., serial number, expiration date, etc.) may be sent with license code 305 to device 107 without being encrypted. Other formats and encryptions are also contemplated (e.g., license code 305 may include an encrypted hash of digital signature 903 and unique identifier 303 while other license data 309 is not encrypted). In some embodiments, both license code 305 and other data 309 may be encrypted. In some embodiments, both license code 305 and other data 309 may be unencrypted.

At 409, license system 109 may send license code 305 (and, in some embodiments, license data 309) to device 107. For example, license system 109 may transmit license code 305 (which may be encrypted) (and, in some embodiments, other license data 309) to device 107 over network 101.

At 411, if device 107 does not have a current license, license system 109 may notify device 107 (or, for example, user 105) that device 107 does not have a current license. For example, license system 109 may send an electronic mail message to user 105 notifying user 105 that device 107 does not have a current license. The message may provide a link (e.g., a URL (Uniform Resource Locator) link) to user 105 to access for information on how to acquire a license. Information may also be sent to user 105 if, for example, the device's license is about to expire. In some embodiments, license system 109 may send license code 305 which includes information on the past date of the license such that device 107 may make the determination that the license is no longer current.

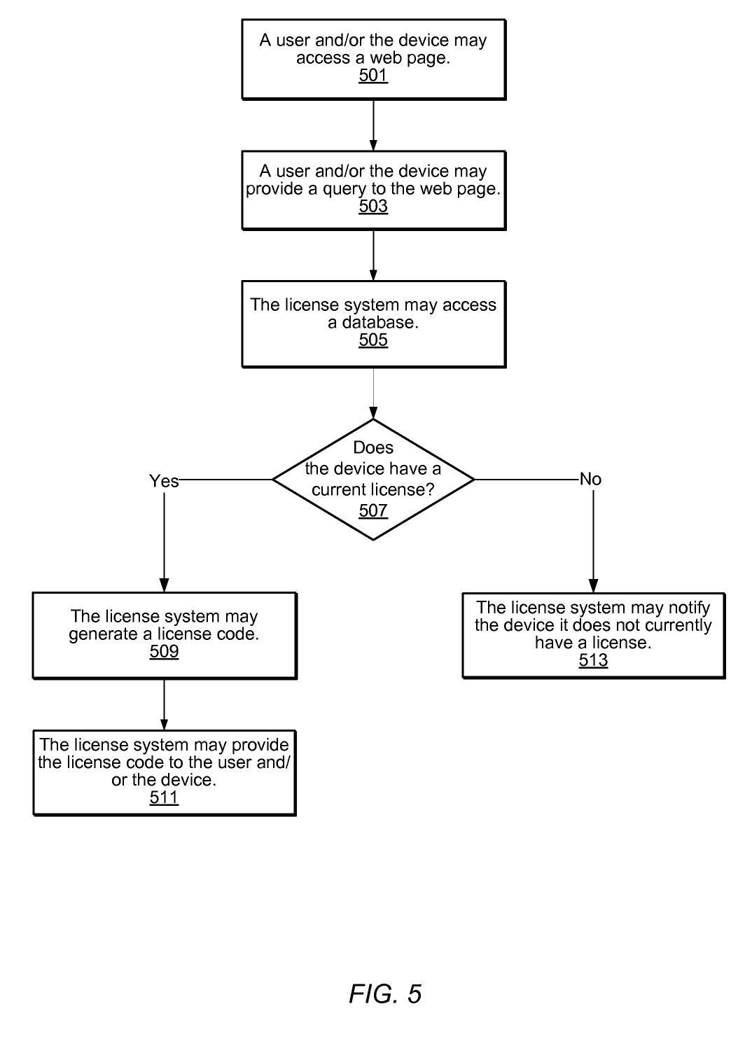

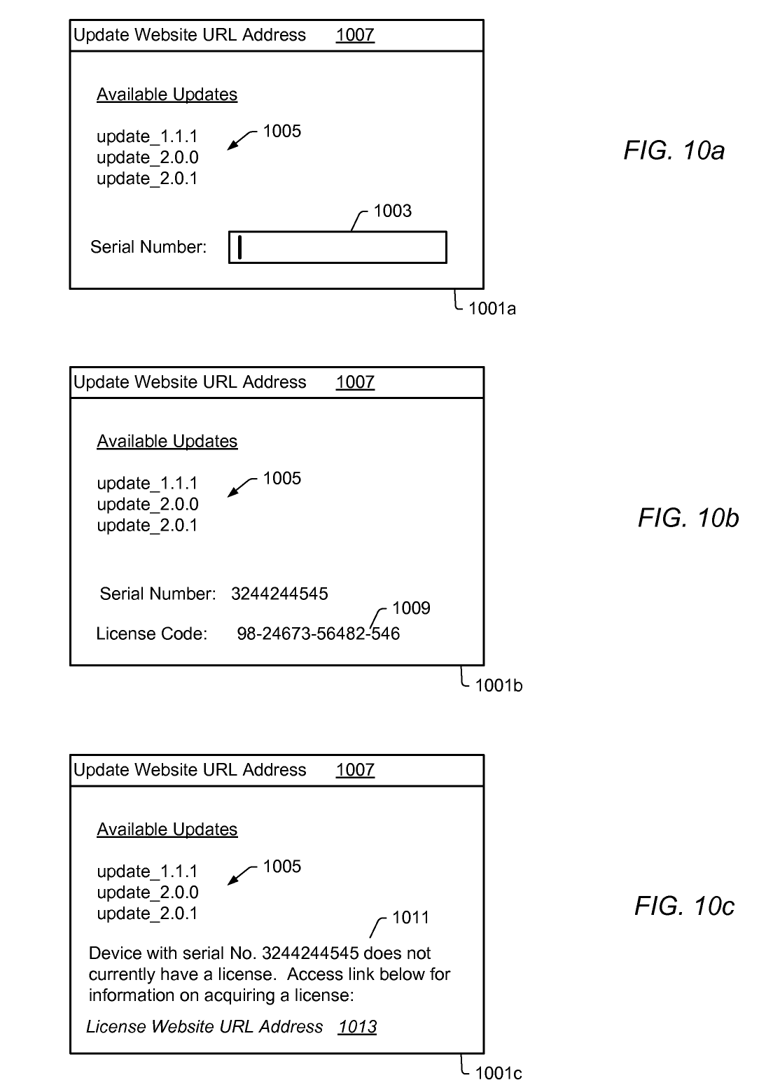

FIG. 5 illustrates a flowchart of an embodiment of a method for providing license code 305 to device 107 through web page 1001a (e.g., see FIG. 10a). It should be noted that in various embodiments of the methods described below, one or more of the elements described may be performed concurrently, in a different order than shown, or may be omitted entirely. Other additional elements may also be performed as desired. In some embodiments, a portion or the entire method may be performed automatically by a computer system.

At 501, user 105 and/or device 107 may access web page 1001a. For example, device 107 may automatically access web page 1001a when device 107 is connected to network 101 for the first time. As another example, user 105 may access a user interface of web page 1001a dedicated to providing license codes 305 (e.g., by entering a website address 1007). Web page 1001a may also provide other information. For example, web page 1001a may allow user 105 to view what software updates 1005 are available for device 107.

At 503, user 105 and/or device 107 may submit query 301 (e.g., by providing identifier 303, unique to device 107) to web page 1001a (e.g., in interface text box 1003) linked to server 315. For example, user 105 may input the device's serial number into text box 1003 of web page 1001a. In some embodiments, identifier 303 may be downloaded to web page 1001a (e.g., automatically by device 107). Other methods of providing identifier 303 are also contemplated. In some embodiments, user 105 and/or device 107 may provide identifier 303 and/or query 301 to server 315 and/or license system 109 without interfacing with web page 1001a.

At 505, license system 109 may access database 311 that includes information associated with a license for unique identifier 303.

At 507, license system 109 may determine if device 107 requesting the license currently has a license.

At 509, if device 107 has a current license, license system 109 may generate license code 305 and, at 511, license system 109 may provide license code 305 to user 105 and/or device 107 (e.g., by displaying code 305 (e.g., displayed as code 1009) on web page 1001b in FIG. 10b and/or downloading code 305 to device 107). In some embodiments, identifier 303 or other query information and/or license code 305 may be sent between device 107 or the user's computer system and license system 109 using SSL (Secure Sockets Layer) or TLS (Transport Layer Security) (or using other security measures). In some embodiments, user 105 may enter code 305 into device 107 (e.g., if code 305 is displayed on web page 1001). In some embodiments, other license data 309 may also be sent and/or displayed with license code 305 (e.g., in some embodiments, license code 305 may not include an expiration date and/or unique identifier 303 but this data may instead be displayed (e.g., unencrypted) with encrypted license code 305 (which may be an encrypted digital signature)). In some embodiments, if device 107 is connected to a computer system used by user 105 to access web page 1001a, user 105 may use keyboard shortcuts and/or a computer clipboard to “cut and paste” license code 305 displayed by web page 1001b into, for example, a code receiving graphical box displayed on a display of device 107.

At 513, if device 107 does not have a current license, license system 109 may notify user 105 and/or device 107 that device 107 does not currently have a license. For example, message 1011 to user 105 may be displayed on web page 1001c (see FIG. 10c). In some embodiments, information and/or link 1013 may be displayed to assist user 105 in acquiring a license. In some embodiments, license system 109 may display license code 305 which includes information on the past date of the license such that device 107 may make the determination that the license is no longer current.

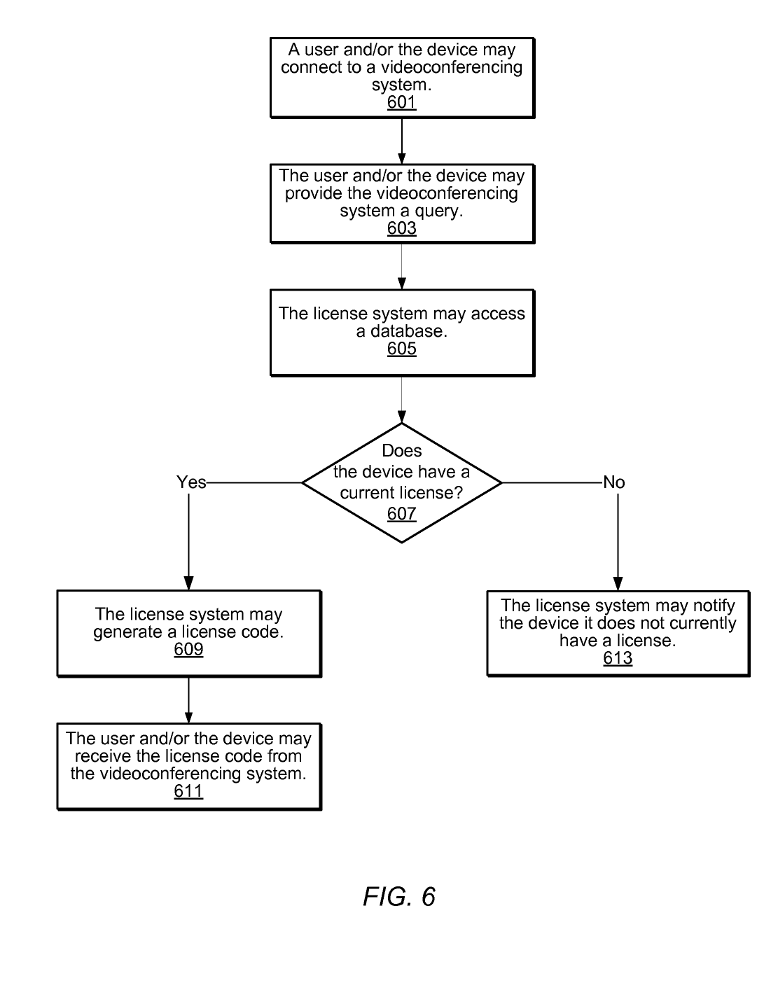

FIG. 6 illustrates a flowchart of an embodiment of a method for providing license code 305 to device 107 from a remote video conferencing system. It should be noted that in various embodiments of the methods described below, one or more of the elements described may be performed concurrently, in a different order than shown, or may be omitted entirely. Other additional elements may also be performed as desired. In some embodiments, a portion or the entire method may be performed automatically by a computer system.

At 601, user 105 and/or device 107 may connect to videoconferencing system 317. In some embodiments, videoconferencing system 317 may be a local video conferencing system or may be remote to device 107. In some embodiments, license system 109 may be resident on an audio-only device (e.g., speakerphone 205). Other license system placements are also contemplated. In some embodiments, device 107 may be connected to a videoconferencing system that may connect (e.g., in a videoconference call) to videoconferencing system 317 through network 101. For example, device 107 (and/or user 105) may have an IP (Internet protocol) address to videoconferencing system 317 (and/or, for example, web page 313/server 315) to use in connecting to license system 109. While network 101 is shown in FIG. 3c, in some embodiments, device 107 may be a local device (e.g., codec 209 or camera 204) on videoconferencing system 317 and may connect to videoconferencing system 317 through local connections (e.g., a local cable or wireless connection).

At 603, user 105 and/or device 107 may send a query 301 (e.g., including identifier 303 unique to device 107) to videoconferencing system 317. For example, identifier 303 may be sent to videoconferencing system 317 encrypted in a video signal, audio signal, (e.g., in metadata with the video or audio signal), etc. Other formats are also contemplated.

At 605, license system 109 on videoconferencing system 317 may access database 311 that includes information associated with a license for unique identifier 303.

At 607, license system 109 on videoconferencing system 317 may determine if device 107 requesting the license currently has a license.

At 609, if device 107 has a current license, license system 109 on videoconferencing system 317 may generate license code 305 and, at 611, license system 109 may provide license code 305 to device 107 (e.g., by sending license code 305 in a video signal, audio signal, (e.g., in metadata with the video or audio signal), etc). In some embodiments, license system 109 may send other license data 309 (e.g., which may be unencrypted) with license code 305 (e.g., which may be encrypted).

At 613, if device 107 does not have a current license, license system 109 may notify user 105 and/or device 107 that device 107 does not currently have a license. For example, videoconferencing system 317 may display a video message at device 107 to notify user 105 that a license needs to be acquired. In some embodiments, license system 109 may send license code 305 which includes information on the past date of the license such that device 107 may make the determination that the license is no longer current.

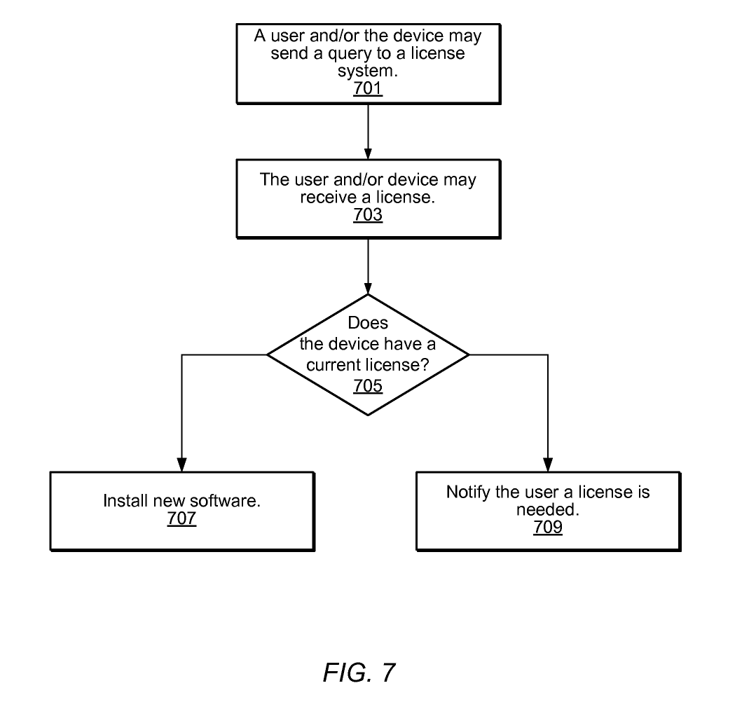

FIG. 7 illustrates a flowchart of an embodiment of a method for using license code 305 in device 107. It should be noted that in various embodiments of the methods described below, one or more of the elements described may be performed concurrently, in a different order than shown, or may be omitted entirely. Other additional elements may also be performed as desired. In some embodiments, a portion or the entire method may be performed automatically by a computer system.

At 701, user 105 and/or device 107 may send query 301 to license system 109. If device 107 is under a current license, license system 109 may generate and send user 105 and/or device 107 license code 305. If device 107 is not under a current license, license system 109 may notify user 105 and/or device 107.

At 703, user 105 and/or device 107 may receive license code 305 at device 107 (if device 107 is under a license). In some embodiments, user 105 and/or device 107 may receive other license data 309 (which may or may not be encrypted). In some embodiments, device 107 may decipher license code 305 and determine a location of relative numbers in license code 305 according to a predetermine template (e.g., a template previously stored on device 107). For example, if the deciphered number is 2425455666040120118334332, according to a predetermined template, device 107 may determine unique identifier 303 is 2425455666, the date is Apr. 1, 2011 and the signature is 8334332 (based on the order of numbers in 2425455666040120118334332). In some embodiments, license code 305 may be encrypted and include a digital signature that device 107 may verify and other license data 309 may not be encrypted but may be accepted by device 107 if the digital signature in license code 305 is verified (e.g., in some embodiments, license code 305 may not have data such as identifier 303 and expiration data but may include only the digital signature). Other combinations of data are also contemplated (e.g., license code 305 may have two pieces of data such as a signature and identifier 303). In some embodiments, both license code 305 and license data 309 may not be encrypted.

At 705, device 107 may use license code 305 to determine if device 107 is authorized for maintenance activities associated with a license. For example, determining if device 107 is authorized for maintenance activities may include comparing the date 805 associated with the expiration of the license to a date associated with the maintenance activity. In some embodiments, the maintenance activity may include applying a software update. When device 107 accesses an update, device 107 may compare a date of the update to a date 805 associated with license code 305 to determine if device 107 has a license for this update. In some embodiments, device 107 may use a public or private key to decipher license code 305 to retrieve, for example, unique identifier 303, license date 805, and signature 903. In some embodiments, license date 805 may indicate when the current license for device 107 expires. Other dates are also contemplated. For example, date 805 may be a start date and a license period (e.g., 5 years) may be included in code 305 (or in other license data 309) to assist in determining if the license is still in effect. Other information may also be included in license code 305 or other license data 309 (e.g., license type 803). License type 803 may also be used in determining whether to apply a certain update (e.g., by comparing license type 803 in license code 305 with a license type associated with/designated in the update). Other information may also be included in license code 305 and/or used in determining whether to apply an update. In some embodiments, license code 305 and/or other license data 309 may be stored on device 107 for later use in determining whether to apply future updates (e.g., by comparing the dates associated with future updates to date 805 associated with license code 305).

In some embodiments, license code 305 may not include date 805. For example, license code 305 may include signature 903 and device 107 may consider receipt of valid license code 305 (e.g., which includes signature 903 that device 107 can verify) as confirmation that a license is in effect for device 107. In some embodiments, date 805 may be included with other license data 309 (e.g., which may not be encrypted).

In some embodiments, device 107 may compare unique identifier 303 in license code 305 (or other license data 309) with the device's unique identifier to verify license code 305 is associated with device 107 (e.g., to prevent unauthorized use of one license code 305 with multiple different devices 107). Other verification techniques may also be used (e.g., signature 903 in license code 305 may be verified). In some embodiments, multiple identifiers (e.g., device unique identifier 303 and MAC address) may be sent with query 301 and sent in license code 305 for use in verifying license code 305.

In some embodiments, device 107 may keep license code 305 for future reference. For example, device 107 may not request a license code 305 each time device 107 attempts to install a software update, but may instead refer to the date included in license code 305 received previously for device 107. In some embodiments, device 107 may send a new query periodically and/or at the expiration of the previous license. Other query timing is also contemplated. In some embodiments, license code 305 (and/or date 805) may be stored on device 107 in an encrypted format to prevent tampering between license code access.

At 707, if code 305 indicates device 107 is covered by a license for the date associated with the new software (e.g., a software update), the software may be installed. If not, at 709, user 105 may be notified (and, for example, led to a web page where user 105 can purchase a license for the software). In some embodiments, license system 109 may send license code 305 which includes information on the past date of the license such that device 107 may make the determination that the license is no longer current. For example, when device 107 deciphers license code 305, expiration data 805 may be determined to be prior to the date of the new software. The new software may then not be installed on the device 107.

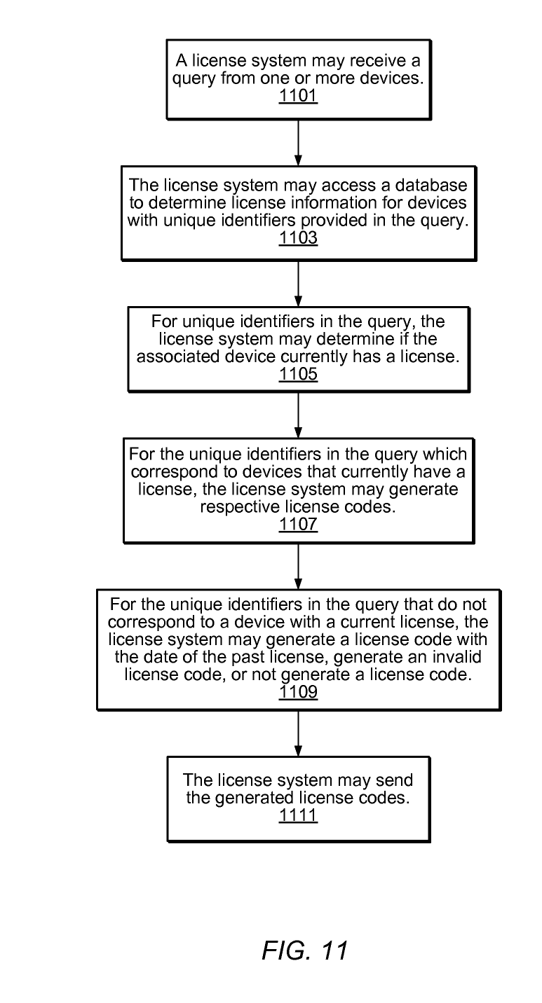

FIG. 11 illustrates a flowchart of a method for sending multiple license codes 305 (e.g., see FIGS. 3d-e) from license system 109 for multiple devices 307a-c, according to an embodiment. It should be noted that in various embodiments of the methods described below, one or more of the elements described may be performed concurrently, in a different order than shown, or may be omitted entirely. Other additional elements may also be performed as desired. In some embodiments, a portion or the entire method may be performed automatically by a computer system.

At 1101, license system 109 may receive query 301 from one or more devices 107 (e.g., devices 307a-c as seen in FIGS. 3d-e). In some embodiments, license system 109 may receive queries 301 from each device 307 (“device 307” used herein to generally refer to one or more of devices 307a-c) or may receive query 301 with license code requests for multiple devices (e.g., device 307 or management system 313 may generate query 301 requesting license codes 305 for multiple devices 307). Management system 313 may include a management server, a codec 209, MCU (Multipoint Control Unit), etc. communicatively coupled (e.g., through wired/wireless connections, a network, etc.) to one or more devices 307. In some embodiments, query 301 may include unique identifiers 303 for each device 307 for which license code 305 is requested. In some embodiments, each device 307 may provide unique identifier 303 in a separate query 301 or, for example, management system 313 may include respective unique identifiers 303 for devices 307 in query 301 sent by management system 313 to license system 109. In some embodiments, management system 313 may collect unique identifiers 303 (e.g., from respective devices 307 directly, or, for example, from user input). Management system 313 may also collect license codes 305 when received from license system 109 for various devices 307.

At 1103, license system 109 may access database 311 to determine license information for devices 307 with unique identifiers 303 provided in query 301.

At 1105, for unique identifiers 303 in query 301, license system 109 may determine if the associated device 307 currently has a license.

At 1107, for unique identifiers 303 in query 301 which correspond to devices 307 that currently have a license, license system 109 may generate respective license codes 305 (e.g., using code generation algorithm 901).

At 1109, for unique identifiers 303 in query 301 that do not correspond to device 307 with a current license, license system 109 may generate license code 305 with the date of the past license, generate an invalid license code 305, or not generate license code 305.

At 1111, license system 109 may send the generated license codes 305 to device 307 (and/or management system 313). For example, as seen in FIG. 3d, license system 109 may place license codes 305 in license code file 319 to send to device 307. In some embodiments, license system 109 may include information in license code file 319 noting which unique identifiers 303/devices 307 do not have a current license. Each device 307 may receive license code file 319, review license codes 305, determine which license code 305 is associated with the respective device 307, and use license code 305 associated with the respective device 307. In some embodiments, reviewing license codes 305 to determine which license code 305 is associated with the respective device 307 may include deciphering the license codes 305 to determine which license code 305 include the unique identifier 303 associated with the respective device 307. In some embodiments, reviewing license codes 305 to determine which license code 305 is associated with the respective device 307 may include reviewing identifiers (e.g., unique identifiers 303) in license code 311 associated with the license codes 305 to determine which license code 305 is associated with the respective device 307. Other determinations are also contemplated. In some embodiments, management system 313 may review the received license codes 305 (e.g., received in license code file 319 or received separately) and distribute the license codes 305 to respective device 307 (e.g., respective devices 307 communicatively coupled to management system 313) (e.g., see FIG. 3e). In some embodiments, license system 109 may also include other license data 309 for one or more device 307 with the license codes 305 (e.g., in license code file 319 or a separate file).

Embodiments of a subset or all (and portions or all) of the above (e.g., the above methods, the license system 109, code generation algorithm 901, etc.) may be implemented by program instructions stored in a memory medium or carrier medium and executed by a processor. A memory medium may include any of various types of memory devices or storage devices. The term “memory medium” is intended to include an installation medium, e.g., a Compact Disc Read Only Memory (CD-ROM), floppy disks, or tape device; a computer system memory or random access memory such as Dynamic Random Access Memory (DRAM), Double Data Rate Random Access Memory (DDR RAM), Static Random Access Memory (SRAM), Extended Data Out Random Access Memory (EDO RAM), Rambus Random Access Memory (RAM), etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer that connects to the first computer over a network, such as the Internet. In the latter instance, the second computer may provide program instructions to the first computer for execution. The term “memory medium” may include two or more memory mediums that may reside in different locations, e.g., in different computers that are connected over a network.

In some embodiments, a computer system at a respective participant location may include a memory medium(s) on which one or more computer programs or software components according to one embodiment of the present invention may be stored. For example, the memory medium may store one or more programs that are executable to perform the methods described herein. The memory medium may also store operating system software, as well as other software for operation of the computer system.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1 A method, comprising:
receiving a query at a license system, wherein the query includes an identifier unique to a device;
the license system accessing license information corresponding to the device associated with the unique identifier; and
the license system sending a license code, wherein the license code includes information corresponding to the license information.

2. The method of claim 1, further comprising the licensing system generating the license code with a digital signature, and wherein the license system sending the license code further comprises the license system further sending other unencrypted license data to the device.

3. The method of claim 2, wherein generating the license code comprises generating a license code at least partially using the identifier and a digital signature.

4. The method of claim 1, wherein the license system is an HTTP server or a video conferencing system.

5. The method of claim 1, wherein the identifier is a serial number of the device or a MAC address of the device.

6. The method of claim 1, wherein the license information includes a date associated with an expiration of the license.

7. The method of claim 1, wherein receiving the query at the license system comprises receiving a plurality of identifiers unique to respective devices of a plurality of devices and wherein the license system sending the license code comprises the license system sending a plurality of license codes corresponding to respective devices of the plurality of devices.

8. A method, comprising:
sending a query to a license system, wherein the query includes an identifier unique to a device;
receiving a license code, wherein the license code includes license information for the device; and
using the license code to determine if the device is authorized for maintenance activities associated with a license.

9. The method of claim 8, further comprising receiving other unencrypted license data at the device and wherein the license code is encrypted.

10. The method of claim 8, wherein the license code includes information associated with a date associated with an expiration of the license.

11. The method of claim 10, wherein determining if the device is authorized for maintenance activities comprises comparing the date associated with the expiration of the license to a date associated with the maintenance activity.

12. The method of claim 8, wherein the maintenance activity is applying a software update.

13. The method of claim 8, wherein the license code is generated using at least part of an identifier and a digital signature.

14. The method of claim 8, wherein sending the query to the license system is performed by the device when the device is initially connected to the Internet.

15. The method of claim 14, wherein sending the query to the license system is performed by the device when the device is determining whether to perform the maintenance activity.

16. The method of claim 8, wherein receiving a license code comprises receiving the license code from a user.

17. The method of claim 8, wherein receiving a license code comprises:
a user accessing a web page;
a user entering an identifier unique to the device into the web page; and
a user receiving the license code from the web page.

18. The method of claim 8, wherein receiving a license code comprises:
connecting to a remote videoconferencing system;
providing the remote videoconferencing system an identifier unique to the device;
receiving the license code from the remote videoconferencing system.

19. A computer-readable storage medium, comprising program instructions, wherein the program instructions are computer-executable to:
receive a query, wherein the query includes an identifier unique to a device;
access license information corresponding to the device associated with the unique identifier; and
send a license code, wherein the license code includes information corresponding to the information associated with the license.

20. The computer-readable storage medium of claim 19, wherein the program instructions are further executable to generate the license code with a digital signature, and wherein sending the license code further comprises sending other unencrypted license data to the device.

21. The computer-readable storage medium of claim 20, wherein generating the license code comprises generating a license code at least partially using the identifier and a digital signature.
